(19) United States
(12) Patent Application Publication
(10) Pub. No.: US 2017/0059265 A1
(43) Pub. Date: Mar. 2, 2017

(54) RECORDING DEVICES AND SYSTEMS

(71) Applicants: Curtis Winter, Spring Branch, TX (US); Paul Aaron, Los Angeles, CA (US); Christopher Brandon Doughty, Tiny (CA)

(72) Inventors: Curtis Winter, Spring Branch, TX (US); Paul Aaron, Los Angeles, CA (US); Christopher Brandon Doughty, Tiny (CA)

(21) Appl. No.: 15/253,844

(22) Filed: Aug. 31, 2016

Related U.S. Application Data
(60) Provisional application No. 62/212,391, filed on Aug. 31, 2015.
(60) Provisional application No. 62/290,987, filed on Feb. 4, 2016.

(51) Int. Cl. F41A 17/08; F41G 11/00; H04N 5/91; H04N 7/18; H04N 5/232

(52) U.S. Cl. CPC F41A 17/08; H04N 7/188; H04N 7/181; H04N 5/23203; H04N 5/91; H04N 5/23238; F41G 11/003

(57) ABSTRACT

An improved gun and body camera system having a weapon mounted camera, a body camera and a forearm communicator. In one aspect, the weapon mounted camera, body camera and forearm communicator are integrated into a single system for recording and synchronizing audio and video. In another aspect, the system can be separated, with each unit (i.e., gun camera, body camera, and forearm communicator) operating independently, as a stand-alone device. Each device preferably contains a number of components and sensors, which are used in combination with system software to improve law enforcement and firearm safety.

### RELATED APPLICATIONS

This application claims priority from U.S. Provisional Patent Application No. 62/212,391, which was filed on Aug. 31, 2015, and from U.S. Provisional Patent Application No. 62/290,987, which was filed on Feb. 4, 2016, which are hereby incorporated by reference in their entirety.

### STATEMENT REGARDING FEDERALLY SPONSORED RESEARCH OR DEVELOPMENT

Not Applicable

### STATEMENT REGARDING PARTIES TO A JOINT RESEARCH AGREEMENT

Not Applicable

### REFERENCE TO SEQUENCE LISTING, TABLE, OR COMPUTER PROGRAM LISTING

Not Applicable

### STATEMENT REGARDING PRIOR DISCLOSURES BY THE INVENTOR OR A JOINT INVENTOR UNDER 37 C.F.R. 1.77(B)(6)

Not Applicable

### TECHNICAL FIELD

This disclosure relates to a recording device and system and, more specifically, to a novel gun and body camera system for use in law enforcement, corrections, the military and the security industry, for example.

### BACKGROUND ART

Law enforcement has long used various camera devices as a means of increasing officer safety and documenting evidence of events. Typically, these devices are stand-alone cameras only. They generally do not integrate with each other, nor do they automatically trigger certain events designed to make the job of a law enforcement officer easier or safer.

### SUMMARY

With reference to the corresponding parts, portions or surfaces of the disclosed embodiment, merely for the purposes of illustration and not by way of limitation, the present invention provides an improved gun and body camera system having, in various embodiments and combinations, a weapon mounted camera, a body camera and a forearm communicator. In one aspect, the weapon mounted camera, body camera and forearm communicator are integrated into a single system for recording audio and video. In another aspect, the system can be separated, with each unit (i.e., gun camera, body camera, and forearm communicator) operating independently, as a stand-alone device.

In certain embodiments, recording on the weapon mounted camera, body camera and/or forearm communicator begins automatically when a gun is removed from its holster (e.g. not only the gun-mounted camera begins recording when the gun is drawn, but also the body camera and/or forearm communicator); when law enforcement personnel turn on sirens or flashing lights; when law enforcement personnel move out of a predetermined range; and/or when one member of law enforcement reaches a desired distance/proximity to another member of law enforcement who has activated his/her own recording device.

One embodiment includes an Inertial Measurement Unit to detect movement and keep the power circuit on, and also to give precise movement recordings to the device. Another embodiment includes a GPS device and system to report the location of a camera/recording device at any time. A magnetometer may be included in the novel system to report direction of devices compared to magnetic north. Another embodiment integrates an image sensor such as a T4K82 image sensor. A Cortex-A12W Processor, for example, may be used to process the video and serve to control all other sensors and logic.

In other aspects, a proximity sensor is integrated into the system (e.g. in the weapon camera) to detect when a weapon is drawn from its holster. Another embodiment includes a Wi-Fi network chip to transfer data from on board storage and receive data in return; and/or to detect when a camera is in range of another camera. In one embodiment, the system automatically activates one camera if another camera is in this range. The device and system may also include a vibration module to alert a user of any desired status (e.g. after a specified time period after deactivation of recording, or low battery).

In another aspect, the novel system provides live streaming of audio and/or video to a secure encrypted server. In yet another aspect, a forearm communicator provides live video feed from the gun camera via Wi-Fi or Zigbee signal, which allows an officer to see around a corner by aiming his gun, for example, instead of sticking his/her head around to look. The live video feed and Wi-Fi chip/hot spot may also be configured and arranged for real-time viewing by other law enforcement personnel and others at remote locations. In other embodiments, the novel device and system includes a shot counter, Wi-Fi or Bluetooth connection to the officer's cell phone, emergency call button, GPS location of other officers near him/her, and/or instant messaging.

One embodiment of the invention includes a software/firmware system that works in tandem with some or all of the foregoing hardware, features and embodiments to provide additional weapon safety features, including unique applications designed for use with smart phones, for example. In certain embodiments, the cameras described herein contain built in Wi-Fi and/or Bluetooth which allows direct and dedicated connection to software or firmware installed on a user's smartphone, for example. The system/application may contain an updatable database of information relating to multiple weapons/caliber, and weapon/barrel configurations. As described below, the novel software or firmware may then automatically calibrate that information, allowing it to determine the range and velocity of the weapon when fired.

In other aspects, the software/firmware is configured to cross reference geo-location data from a mapping database such as Google Maps and/or Google Terrain, to calculate the angle, direction, trajectory, and range of the weapon prior to firing, to determine whether or not it is safe to fire the weapon in the direction and angle it is pointed in. Using real-time geo-location data on the weapon camera, the novel system also may issue a visual, vibrating and/or sound alert, to notify a user that another user's weapon is pointed at them.

Other aspects and embodiments of the invention provide activation and event tagging. As described below, a body camera may operate in a passive record mode from the time it is activated until the time it is turned off, or deactivated by the user. During passive mode, the camera records video and/or audio data in a loop for a desired amount of time. If the camera is activated by either a user event or defined system sensor event, it may be programmed to start the active recording session, but will include a pre-set period of time from the passive record loop, to ensure that the active recording includes the data that was captured immediately before the active record session started. Also, event tags may be created in a time/date format, which will allow for quick access to specific events in the recorded data.

In other aspects, an accelerometer, altimeter or multiple gyroscopic sensors may be provided, and the camera will automatically turn on, and begin actively recording if the sensors detect any of the following; a sudden change in speed, a shock or sudden jarring motion, sudden drop or increase in elevation, or sudden change of direction or angle. Those same sensors may also be used to create event tags during an active record session.

On-board light sensors on both the body-worn camera and weapon-mounted camera will automatically adjust the resolution of the recording to ensure the best possible footage is captured. For example, when a camera enters an area of low light, the sensors will detect this and drop the resolution to a lower amount (e.g. from 1080p to 480p), as the lower resolution will allow for maximum light absorption. Although the resolution is not as high, better overall image capture will be provided.

The body-worn cameras have multiple on-board sensors that can detect specific movements or sounds that change it from pre-record to active record, and generate event/metadata tagging. For example, the sensor detects sudden change in acceleration or movement, such as the officer beginning to run, or sudden change in direction, if an officer has to pivot or move quickly when reacting to a situation. It can also utilize sounds, such as loud voices, such can be from an officer having to yell a procedural command to a civilian. The body-worn camera can also connect through a wired or wireless system to 3rd party sensors, such as seatbelt sensors or seat pressure sensors in a car, and can be programmed to activate the camera. For example, if an officer has his seatbelt on, the camera may be wirelessly connected to the vehicle's seatbelt sensor system, and the camera will remain in pre-record mode. However, when the officer takes off the seatbelt, as when exiting the vehicle, the camera would automatically change from pre-record to active record. The same would apply if alternatively utilizing the seat pressure sensors in the vehicle. While the sensor detects pressure, the camera will remain in pre-record mode, but the moment pressure is no longer detected, which means the officer has exited the vehicle, the camera will automatically switch from pre-record mode to active record mode.

### BRIEF DESCRIPTION OF THE DRAWINGS

FIG. 1 is a perspective view, showing a weapon camera according to one embodiment of the disclosure.

FIG. 2 is an alternative view of the weapon camera of FIG. 1.

FIG. 3 is a perspective view the weapon camera of FIG. 1 mounted on a firearm.

FIG. 4 is a perspective view of a body camera according to one embodiment of the disclosure.

FIG. 5 is a perspective view of the back side of the body camera of FIG. 4.

FIG. 6 is an alternative view of the top side of the body camera of FIG. 4.

FIG. 7 is a perspective view of a forearm communicator according to one embodiment of the disclosure.

FIG. 8 is a diagram of a recording device system according to one embodiment of the disclosure.

FIG. 9 is a flowchart of a cover sub-routine of a recording device system according to one embodiment of the disclosure.

FIG. 10 is a flowchart of an officer down sub-routine of a recording device system according to one embodiment of the disclosure.

FIG. 11 is a flowchart of an pursuit sub-routine of a recording device system according to one embodiment of the disclosure.

FIG. 12 is a flowchart of a shots fired sub-routine of a recording device system according to one embodiment of the disclosure.

FIG. 13 is a flowchart of a safe shot sub-routine of a recording device system according to one embodiment of the disclosure.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read together with the specification, and are to be considered a portion of the entire written description of this invention.

As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

This disclosure pertains to video/communication technology, and may preferably include each of a body-worn camera, a weapon-mounted camera, a dash camera, a forearm camera/communicator and a military grade computer tablet. Onboard software and firmware allows each device to operate on its own, but also provides for a singular integrated system having the capability of wirelessly pairing multiple devices together. The novel recording device system provides at least two cameras to ensure that, for example, not only is real-time video being recorded during field deployment from a body camera, but also from a specialized gun camera as described herein, which begins recording automatically when the gun is removed from its holster. When dealing with an escalated situation, for example, an officer or agent might forget to activate the gun camera, so the auto-activation of the camera is crucial to ensure both sound and video footage are captured.

The body camera, weapon camera, forearm communicator, and dash camera each have the ability to sync with the other through the use of metadata markers, which will allow for multi-camera viewing of an event, with synced timeline playback. The recording system will preferably not change any raw data during an automated synchronization process, which is a feature of the disclosed video editing software system.

To ensure the integrity of recorded audio and video, the recording system encrypts all data while it is being recorded by any of the described recording devices (for example, according to CJIS standards), and the encrypted data is stored on the device internal hard-drive. The recording system provides for secure data upload from the device to an on-site server or remote cloud server. Each recording device preferably includes software configured to automatically upload video over Wi-Fi when connected to a secure Wi-Fi system, and further includes an ultra-high-speed fiber port that allows for video upload when the recording device is placed in a data-port docking and charging bay. In one embodiment, each device has the ability to establish a dedicated Wi-Fi, Bluetooth or Zigbee connection to a smartphone device that is running corresponding recording device software, and each device preferably supports real-time data streaming via an LTE cellular network to a remote command center, and/or immediate data upload to the secure cloud server.

The recording system is preferably configured to set a default video recording resolution of 4k, but different event activations may trigger a change in video resolution to best suit the situation, based on software and firmware programming. For example, if recording device sensors detect sudden acceleration, which may suggest that an officer is running, the recording system will automatically switch into 720p or 1080p resolution. If an officer steps out of a vehicle, and a device camera is automatically activated, such a recording may be automatically changed to a lower resolution, such as 480p or 720p. If an officer draws a weapon, and thus activates the weapon-mounted camera as disclosed here, both the weapon camera and body camera will immediately record at the highest available resolution, such as 4k. These device programming rules and parameters can be set to meet the needs of each individual or agency.

The disclosed recording device video editing software will also allow for modification of data prior to upload to an on-site server or cloud server. For example, if video footage is recorded in close proximity to an individual at 1080p, and was crystal clear, it may not be required to save and upload the video in the same 1080p resolution. Thus, a user may choose to reduce the video resolution prior to upload, for example to 720p, while still retaining a clear and concise image.

Activation and Event Tagging

In one embodiment of the invention, a body camera operates in a passive record mode from the time it is activated until the time it is turned off, or deactivated by the user. As used herein, passive record mode means recording to a circular buffer such that when the buffer is filled, the writing continues at the oldest point in the buffer, overwriting those contents.

During passive record mode, the camera is recording video and audio data in a loop for a specific amount of time, based on the guidelines stipulated by the user, or for a desired or specified buffer size. The camera records this data for the pre-programmed time-loop, and then starts the loop over, which will see the previously recorded video and audio data being overwritten by the new data.

During a passive recording period, if the camera is activated by either a user event or defined system sensor event, it may be setup to immediately start an active recording session, but will include a pre-set period of time from the passive record loop, to ensure that the active recording includes the data that was captured immediately before the active record session started. This ensures that the recorded data not only includes the event itself, but also the footage that took place immediately before the event. As an example, the camera can be programmed to start the active record session and include anywhere from 1 minute to 30 minutes of the passive record data stored in the data buffer. The amount of passive record data to be included in the active recording session is set by the end user.

Certain embodiments of the disclosure include event tagging, i.e. when a camera is activated manually or automatically, and begins an active record session, it also creates an event tag using device metadata. For example, event tags created by the software may be listed in a time/date format, similar to a menu of music or video tracks on a CD, which allows for quick access to specific events in the recorded data. This eliminates the need to watch and or shuttle through the entire data set.

Event tagging may be encoded with geo-location data, time and date stamp, and other information as may be made available from the sensors and other devices connected through wireless or other means, and may begin an active record session which will be permanently recorded to the camera's storage drive until the user stops active recording, or the camera is turned off. This permanent recording storage is distinct from the passive or temporary buffer which may be overwritten.

In certain embodiments, both the active record and event tagging on the body camera can be activated manually by the user, e.g. by pressing 2 buttons on either side of the camera simultaneously, or through other defined inputs available via the camera components or interconnected devices, and can be turned off and go back into passive record mode by another user action or pre-defined sensor event, e.g. pressing both buttons again, and holding for 3 full seconds or similar period.

Accelerometer(s), altimeter(s), and gyroscopic sensors are provided in certain embodiments. For example, the camera may be programmed to automatically turn on, and begin actively recording if the sensors detect any of the following: a sudden change in speed, a shock or sudden jarring motion, sudden drop or increase in elevation, or sudden change of direction or angle. This is a pre-defined sensor event or series of system events generated by onboard or other components and requires no input or action by the camera user.

The same sensors and programing used to automatically start an active record session may also be used to create event tags during an active record session. Even when the camera is actively recording, the onboard sensors are still monitoring all incoming data, which means that if they detect any movement or sensory data that would normally initiate an active recording session, the system may be set up to automatically create a new event tag. There are no limits to the amount of event tags that can be created during passive or active record sessions.

In some aspects, once the camera is automatically activated, it will continue to actively record video and audio data until such time as the user deactivates the record mode, or turns the camera off. In other aspects, the video, audio, event tags, and other sensor or component data recorded during an active record session cannot be erased or altered, and remain on the camera's storage drive until the data has linked with the docking system and uploaded the data to cloud storage and/or permanent hard drive, or other robust independent device.

Weapon-Mounted Camera

The disclosed weapon-mounted or weapon-integrated camera preferably fits a variety of firearms currently on the market. In a first embodiment, the camera mount may be installed on any weapon with a Picatinny (or tactical) rail system, via a camera mount attachment. The camera mount attachment is bolted to the weapon mounted camera system. In one aspect, the weapon camera system comprises a HD video sensor which can store and transmit video wirelessly to other devices in range, using a dedicated Bluetooth, Wi-Fi or Zigbee connectivity. In another aspect, the weapon camera system also has an optional flash light and strobe function that uses high brightness LEDs.

In one embodiment, the weapon camera has a system processor, such as the Qualcomm® Snapdragon™ 820 or the ARM® Cortex®-A15, that controls all functions and video processing. Within the onboard device storage, device firmware preferable includes controls and sensor reporting software. The firmware is also in control when the camera is turned on/off and when any data is transferred.

The weapon-mounted camera may include a variety of features, including the following. The device is preferably compact in size, which allows the recording device to fit any gun with a Picatinny rail, or allows for an adapter for firearms without Picatinny rails. The weapon camera may be configured to automatically turn on and record when the attached gun is drawn from its holster. This auto-on feature also preferably initiates an active record session on a body-worn camera corresponding to the same individual, and additionally any other system body-worn cameras within close proximity (for instance, within Bluetooth connectivity range of each other, or within a certain specified distance).

Weapon camera resolution may be preprogrammed or defined by the user, for instance choosing from 480p, 720p, 1080p or 4K. Similarly, recorded frame rates can be individually or manually configured from a choice of 30 FPS, 60 FPS, and 120 FPS, and the device preferably supports the H.265 or other video codec, allowing for maximum data compression and quality. The recording system allows for the weapon camera to connect to any other system recording device, such as the forearm communicator, via any preferred network protocol, such as Wi-Fi.

The weapon camera will also have a GPS locator, which can be used to locate an officer or track a lost or stolen weapon, and additionally include a GPS shot monitoring system that provides exact location, time and direction of the shots fired, as is further described herein. GPS location provided by the weapon camera can also be used in an officer-down situation, wherein the device will transmit an emergency beacon and location information to a central command center.

The weapon camera will preferably run on batteries, and each camera preferably has at least two hours of battery life while recording. Also built into each weapon camera is a noise cancelling microphone. Additional features of the weapon-mounted camera preferably include a rugged, durable, aircraft-grade aluminum body for extreme usage, a sapphire crystal camera lens that is scratch and burn resistant, and may further include an optional mounting system allowing military, police, swat, and other agencies to mount the cameras on different weapons, depending on mission requirements.

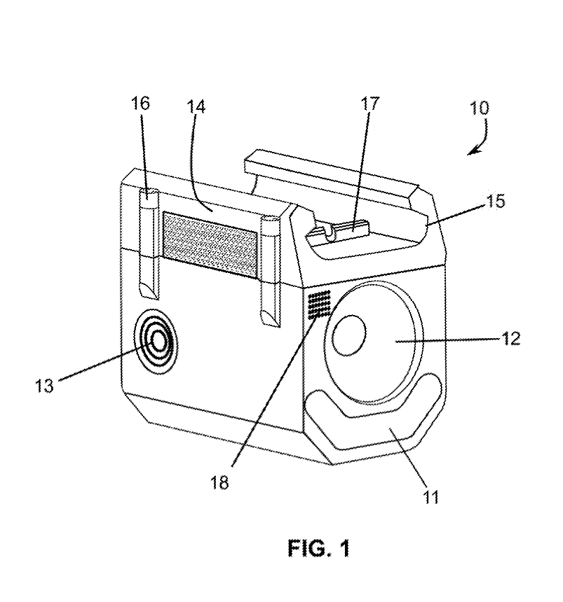

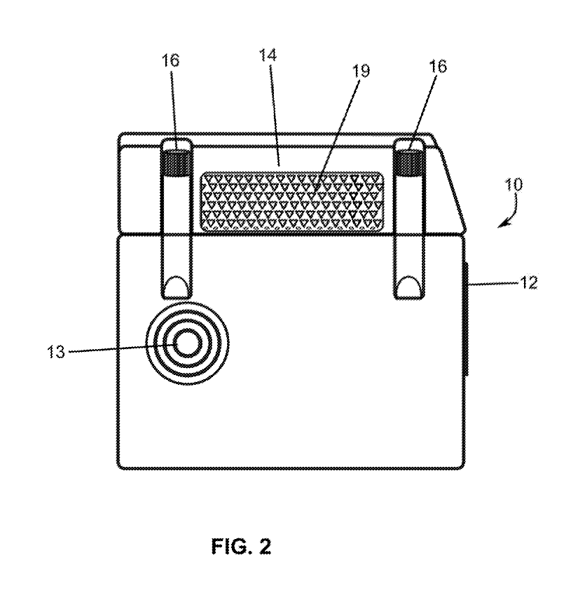

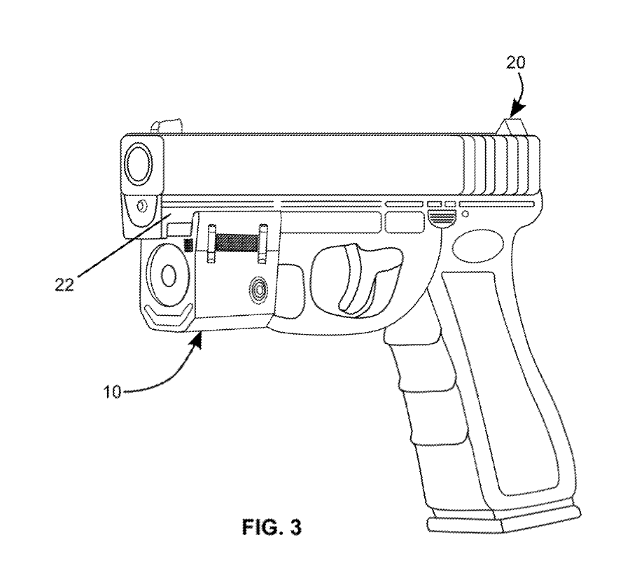

FIGS. 1-3 illustrate one embodiment of a weapon-mounted camera module 10. The camera 10 includes an optional flashlight or strobe light 11, a camera and lens 12 on the front of the unit, a programmable smart switch 13 for turning on/off, and capable of being programmed for some or all of the features described herein, and a Picatinny rail locking device 14 for attaching the camera to a weapon 20. FIG. 1 shows additional detail of the Picatinny rail locking device 17, as well as the rail mounting bolts 16, microphone 18, rail grip 19, and Picatinny rail 15. FIG. 3 illustrates weapon-mounted camera 10 attached to firearm 20 via corresponding Picatinny rail 22. The disclosure is not limited to a Picatinny rail mount, but may use other rail mounts and mounting platforms known to those skilled in the art.

Body Camera

The body camera changes the way that information is typically collected and stored. All video footage will preferably be stored in an encrypted format (for instance, one that meets CJIS guidelines), on the device's data chip, and can be automatically uploaded to a secure server when a secure Wi-Fi connection is available or sent through an optional cellular connection when immediate streaming or upload is required. The preferred body camera has an optional front mounted video screen to show subjects that they are being recorded. If in range and connected to a Wi-Fi or Zigbee network, and/or optional cellular network using a connection to a smartphone using device software application as disclosed herein, the body camera unit can also stream in real-time to a command center or to an officer in charge. As will be described in further detail below, in the event that a situation escalates, the on-site officer can summon help by pushing one button, which will then broadcast live video and GPS location of the officer to a command center as well as to nearby system forearm communication units.

Body camera specifications may preferably include a 148 degree wide angle sapphire crystal lens, a rugged aircraft grade aluminum body, and a magnetic clip system that allows for easy mounting on any type of uniform. Similar to the weapon-mounted camera, the body camera resolution may be preprogrammed or defined by the user, for instance choosing from 480p, 720p, 1080p or 4K. Similarly, recorded frame rates can be individually or manually configured from a choice of 30 FPS, 60 FPS, and 120 FPS, and the device preferably supports the H.265 or other video codec, allowing for maximum data compression and quality. Further, the recording system allows for the body camera to connect to any other system recording device, such as the forearm communicator, via any preferred network protocol, such as Wi-Fi.

The body camera of the instant disclosure provides for optional pre-event recording with a programmable record feature, event tagging for active recording sessions, and recording of various sensor data, as is further described herein. Any of the body camera features can be button activated or triggered via voice command, as desired by the user.

Provided as a software feature of the body camera of the disclosed system is an automated recording/event tagging mode, using the body camera's on-board sensors to detect and record sensed events such as motion, including a sudden change in height, acceleration, or direction. The system is able to detect and record proximity to another system camera that is in active record mode. An infrared sensor may be configured to turn the body camera on at a certain time, for instance when exiting a patrol car. Weapon camera activation will also activate all body worn cameras within a specified range.

Connection to an in-car seatbelt sensor system allows for the body camera to automatically shift from a pre-record mode to an active record mode when a seatbelt is not engaged or becomes disengaged. Alternatively, connection to an in-car seat pressure system allows for the system to be configured to similarly change the body camera from a pre-record mode to an active record mode when the seat pressure sensor does not detect any weight.

Multiple onboard sensors systems built into each body camera may include a GPS, accelerometer and altimeter, allowing for the tracking of location, speed and elevation; a compass and one or more gyro meters, to allow for the direction and angle of the camera to be calculated; and an optional body-vitals sensor system may be utilized.

The preferred body camera is battery powered, and has at least a twelve-hour battery life for video recording. Wireless charging and automatic data upload to cloud or on-site servers are preferred features, as are a front-facing OLED screen and dual noise cancelling microphones with individual audio streams. As will be described further herein, the body camera may also be equipped with an automated and manual “officer needs assistance” S.O.S. broadcast mode.

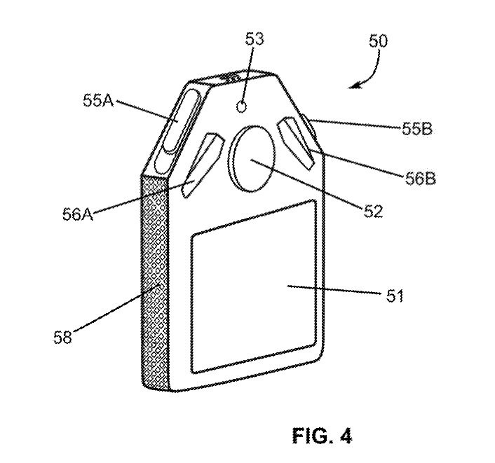

Referring now to the drawings, FIGS. 4-6 show one embodiment of a body camera 50. In this embodiment, a video screen/display 51 is provided which displays the video being captured, and which may be programmed to display other features, as described herein. The camera and lens 52 in this embodiment are above the screen 51. In one aspect, an IR receiver lens 53 is provided and, in another aspect, a bi-directional microphone 54 is provided. Programmable smart switches 55A, 55B, 56A, and 56B are provided in certain embodiments; such switches may be positioned anywhere on the body camera unit. In another aspect, the novel camera system includes a battery status indicator 57 and a tactile grip 58.

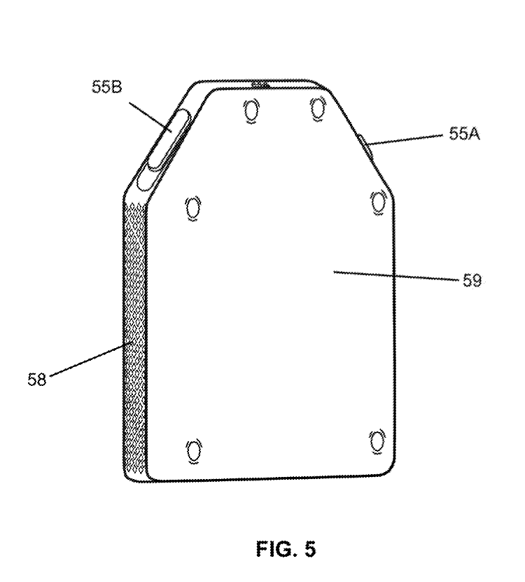

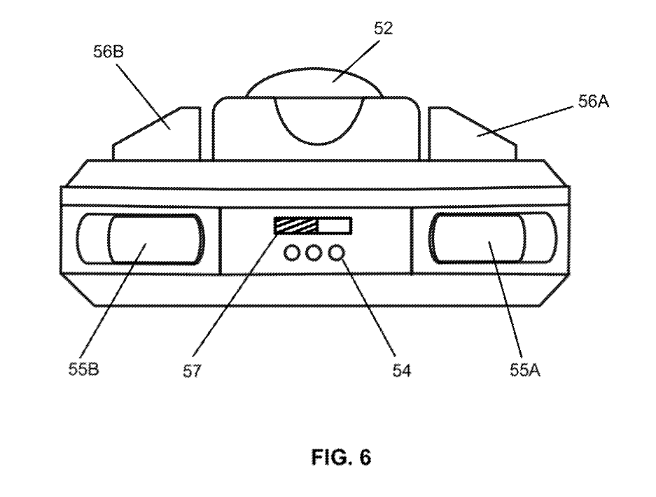

FIG. 4 is a front view of an inventive body camera 50 which illustrates IR receiver 53, a 145-150 degrees lens 52, and a live viewing screen 51. FIG. 5 is a rear perspective view illustrating the magnetic mount 59 and non-slip grip 58 in one embodiment of the disclosure. FIG. 6 is a top perspective view illustrating the smart switches 55A, 55B, 56A, and 56B, in addition to bi-directional microphone 54 and battery status indicator 57.

360 Degree Vehicle-Mounted Camera

The disclosed recording device system also provides for a 360 degree camera (not illustrated), which is designed to mount on the roof or light-bar of a law enforcement vehicle, but due to versatility, it can be mounted in multiple ways depending on the type of vehicle and intended use of the vehicle/camera. A 360 camera has the unique ability to observe and record video and audio from every conceivable position around a vehicle, and will allow a viewer to easily pan and shift through 360 degrees of video while using video editing software as disclosed herein. The 360 camera is preferably powered by the vehicle it is mounted to through a wired connection to the vehicle's power system and/or the vehicle's light-bar system.

The 360 camera can be programmed to use a pre-record loop, until it is activated and begins a dedicated recording session, or it can be programmed to begin actively recording the moment a vehicle is turned on. Additionally contemplated are multiple sensors that, when triggered, will activate the 360 camera's recording system, which can be programmed according to the policies and procedures of each individual police or security agency.

The 360 camera is designed to follow an officer or other security personnel whenever they exit their vehicle, and will also sync with the officer's active body-worn camera, weapon-mounted camera, and/or forearm camera using metadata markers, as disclosed herein. The novel recording device system will allow for perspective viewing from multiple angles prior to upload to a central server for long-term storage, or if required for evidentiary purposes. The disclosed data-sync option during playback allows for multiple video and audio streams to be combined into one video for better viewing and/or evidence production, but the disclosed method preferably does not permanently alter or combine any original footage that is recorded. The original data recorded by each camera device will remain intact, and will be stored in its original, unedited format, in addition to any modified or synchronized version that may be created using the disclosed video editing software tools.

Features of the 360 camera will preferably include the following, which can be modified and programmed specifically to meet each agency's policy requirements. 4×180-degree wide angle sapphire crystal lenses, allowing for two-times redundancy, a rugged, aircraft-grade aluminum body, and a roof or light bar mounting system.

Similar to the weapon-mounted camera and body camera described above, the 360 camera will preferably include support for manual and automatic 480p, 720p, 1080p and 4K resolution, H.265 or other video codec for maximum data compression and quality, and choice of 30, 60, 120 frames per second recording as determined based on a triggering event. The 360 camera preferably defaults to a pre-event recording mode with a programmable recording loop, and further includes support for event metadata tagging for each active record session. Metadata markers allow for easy navigation, editing, and multi-device syncing.

Disclosed is support for an officer “follow mode” using GPS tracking software on the any of the disclosed camera devices to track officer's movements outside of the vehicle. An automated “active record” mode (which may, for example, turn on the vehicle mounted 360 camera) can be triggered when device sensors detect a siren or light bar activation; when motion such as a sudden change in height, acceleration, or direction is detected; if proximity to another system device in active record mode is discovered; or if a connected weapon camera is activated. Other programmable activation options available for the 360 camera include automated and manual “officer needs assistance” S.O.S. broadcast mode, as is further described herein.

The 360 camera is preferably equipped with multiple onboard sensors including GPS and accelerometer (to measure location and speed), compass and gyro meters (to determine direction and angle of camera), and wireless or wired data capabilities to upload data to a cloud or on-site server. A preferred in-vehicle hard drive will preferably offer enough space to save at least 18 to 35 hours of recorded data. Additional preferred elements include quad-channel noise cancelling microphones with individual audio streams and a power supply that can be wired or wireless (such as by using near field communication).

Forearm Communicator

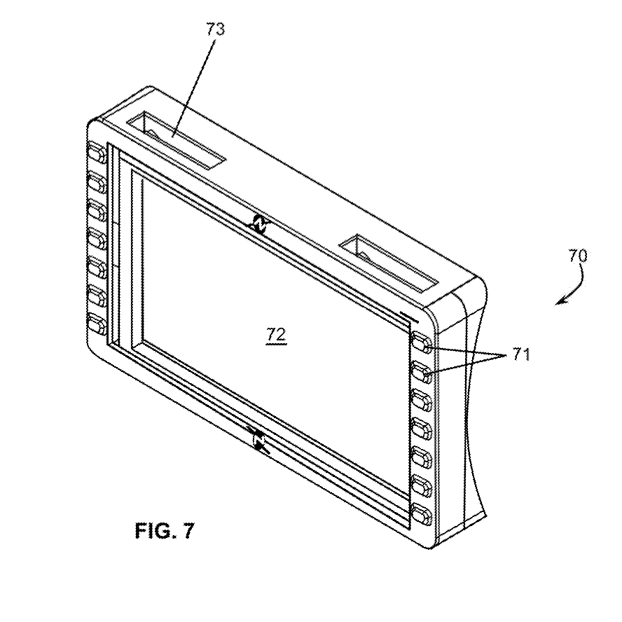

A disclosed multi-function forearm communication system/unit may be configured to provide live video feed from the disclosed gun camera via Wi-Fi signal, which allows an officer to see around a corner by aiming his gun, instead of sticking his/her head around to look. Several features of the forearm communicator are illustrated and described with reference to FIG. 7.

FIG. 7 is a front perspective view of forearm communicator 70 with tactile programmable buttons 71, display screen 72, and holes for arms attachment straps 73. Tactile buttons 71 are entirely programmable and allow for user desired option control, as described herein.

In one embodiment, the forearm communicator 70 is constructed from a redesigned android cell phone chassis that is repurposed not only for communication but as a direct visual monitor from a weapon camera, body camera, or any other camera that has access to a passkey of the forearm device. Device 70 preferably has both Wi-Fi and LTE network capabilities and can be connected to any cellphone network. Tactile buttons 71 have been included to allow for an operator to use gloves instead of the touch screen. A preferred embodiment can show a user's present location as well as the location(s) of any other system devices being used by other users. With the android operating system, apps may be added or removed from the communicator, as desired.

The forearm communicator preferably includes Wi-Fi, Zigbee, and LTE cellular data streaming capabilities, along with relative signal strength indicators, as necessary. In one system embodiment, the forearm communicator connects via Wi-Fi or Zigbee connectivity to the body-worn camera and weapon camera of the device user (and other users). Further, Wi-Fi or Bluetooth connectivity may allow for integration with other smartphones and additional Bluetooth devices.

The forearm communicator software will preferably include a shot counter that displays a number of shots fired (which are automatically detected). Functionality further includes a call-out feature that provides a command center with detailed location, speed and direction when it is detected or manually triggered that an officer is in pursuit of a vehicle or suspect. This functionality allows an officer to focus on driving and not on radioing the command center. An agency can be further integrated with the disclosed system by the use of integrated GPS-assisted intercept, which will provide turn by turn directions to any additional officers as to the best route to intercept a suspect being pursued.

The forearm communicator may be configured with a flip and fold design, thereby making the device ambidextrous and allowing the device to be worn on either arm or on a waist belt of a user. Multi-screen overlay configuration allows for transparent programs, such that a user can set various programs to be open while all other open programs still remain visible. The disclosed forearm communicator will further be programmed with an instant messenger system, and include an SOS panic button, which sends a distress signal that is automatically triggered when certain events are received by onboard sensors, but can also be manually activated by the officer, as is further described herein.

The screen of the forearm communicator is preferably daylight visible and anti-glare, and the device is preferably constructed with a rugged design having a durable rubber outer coating that is both waterproof and impact resistant.

System Sensors

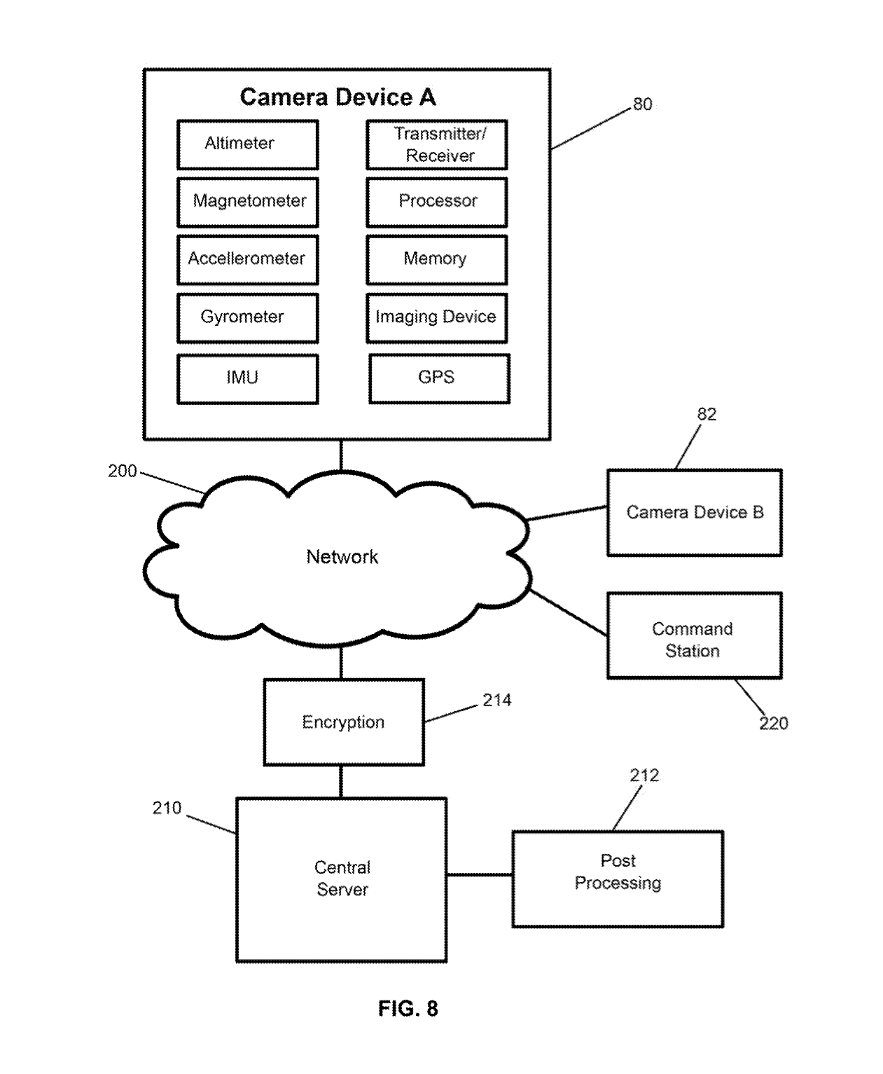

The functionality of any given device within the disclosed recording device system is now described with reference to FIG. 8. Camera device 80 may be any of the gun-mounted camera, body-worn camera, vehicle mounted camera, or forearm communicator, as described above. Each device preferably contains a number of components and sensors, the uses of each is described further below. Each device is connected to one or multiple wireless networks 200, capable of using at least one or all of Wi-Fi, LTE, Bluetooth, Zigbee, or other wireless network protocol. Such capability allows for device 80 communication with other devices 82, a central server 210, a command station 220, and still other devices as deemed necessary by a user. In a preferred embodiment, all communications are saved to server 210, and are encrypted using an encryption 214 standard such as CJIS. Any post processing 212 of video or audio feeds is preferably accomplished after raw data feeds are saved to central server 210, but those in the art will readily understand that post processing 212 can be accomplished at any other point, including within each device 80 itself.

In one embodiment, one or each of the above-described elements of the recording device system comprises an Inertial Measurement Unit or “IMU.” The IMU has many functions, including 2 main functions: First, the IMU sensor detects movement and keeps the power circuit of the device on. So whenever a device is worn by an officer it will be turned on. If the device sits idle for a preprogrammed amount of time, then it will power down. Second, in the event of an investigation the IMU can give precise movement recordings based on gravity to the device. For example, if an officer falls to the ground, the device may be configured to record its relation to the ground in millisecond intervals. This functionality is also very useful in the weapon camera because it can be used to show the exact angle that a gun is fired.

In one embodiment, the recording device system comprises a GPS unit. The GPS device reports the location of the device (e.g. weapon mounted camera, body camera or forearm communicator) at any time. For example, if a law enforcement officer falls down, and such a fall is detected as described above, and the officer is unable to respond, the device can automatically go into SOS mode. SOS mode will broadcast the user's exact location based on the device location via an LTE interface or Wi-Fi (if in range). Also, GPS location information will be used for investigative reporting of events that have been recorded, since the system software is configured to record location and time at regular intervals.

In one embodiment, the recording device system comprises a magnetometer. This allows for the reporting and recording of the direction of a device compared to magnetic north. For example, when a gun is fired, the system can record and send to central command the exact direction of which the gun was fired. A magnetometer will change magnetic declination based on GPS location.

In one embodiment, the recording device system comprises an image sensor such as a T4K82 image sensor. The T4K82 is a 13 M-pixel high-speed CMOS color image sensor. It has a pixel array of 4208 (H)×3120 (V) and satisfies the 1/3.07-inch optical format. The T4K82 has a pixel size of 1.12 μm. A ‘Bright Mode’ feature delivers high-framerate (slow-motion) video without causing a luminance drop. The T4K82 maintains the low power consumption advantage of a CMOS process without compromising the 30 fps speed at 13M/4K2K resolution. It offers excellent color reproduction by the use of an advanced color noise filter. However, any suitable image sensor can be substituted.

In one embodiment, the recording device system comprises a processor such as a SnapDragon 820 Processor. This chip will not only process video but will serve as the brain to control all other sensors and logic. The system's firmware as described herein may be based around this processor.

In one embodiment, the recording device system comprises a proximity sensor. This proximity sensor is preferably located in the weapon-mounted camera and may be used to detect when a weapon is drawn from its holster.

In one embodiment, the recording device system comprises a Wi-Fi network chip and a Zigbee network chip. These chips are used to transfer data from on-board storage and to receive data in return. These chips may also be used to detect when one device is in range of another system device. For example, when an officer draws his weapon, thus activating a corresponding weapon camera, any other system body-worn cameras in range, including the one worn by the officer that drew his weapon, which are not yet actively recording, may be configured to automatically switch from “pre-record” to “active record”, which will also create an event/metadata tag for each device. If a body-worn camera or weapon-mounted camera is actively recording, and comes within range of any other system body-worn cameras, such device may further be configured to immediately activate all other device cameras within their range. The same automatic application applies to an officer wearing a system body-worn camera that is not actively recording, and comes into range of other system body-worn cameras or weapon-mounted cameras that are actively recording, his body-worn camera will immediately switch from pre-record to active record.

In one embodiment, the recording device system comprises a vibration module. This may be used to alert a user of any desired status that is pre-programmed into the system. For example, when an operator turns a camera off, the vibration module may be programmed to vibrate for one second every thirty seconds to alert the operator to turn the camera back on. Alternatively, if the device battery is low, the system may be programmed to vibrate the device in 0.5 second intervals for 2 seconds, and repeat every 30 seconds.

In one embodiment, the recording device system comprises an iButton or RFID device reader. This sensor may be used to assign a camera to an individual user. For example, a user may wear an RFID or iButton behind a police badge or something unique to that user. The device/camera, when first powered on, may be configured to request that a user identify him/herself. At that time, the user will place the device next to the badge and the reader will read the chip/RFID or iButton and add his or her unique identifier in front of any file name so it can later be linked to that officer. This will also be useful for multiple users since individual cameras can be used by multiple users without any additional file management processes required.

In one embodiment, the recording device system comprises Bluetooth, allowing for data transmission and receipt to connect to other devices.

Software/Firmware Applications

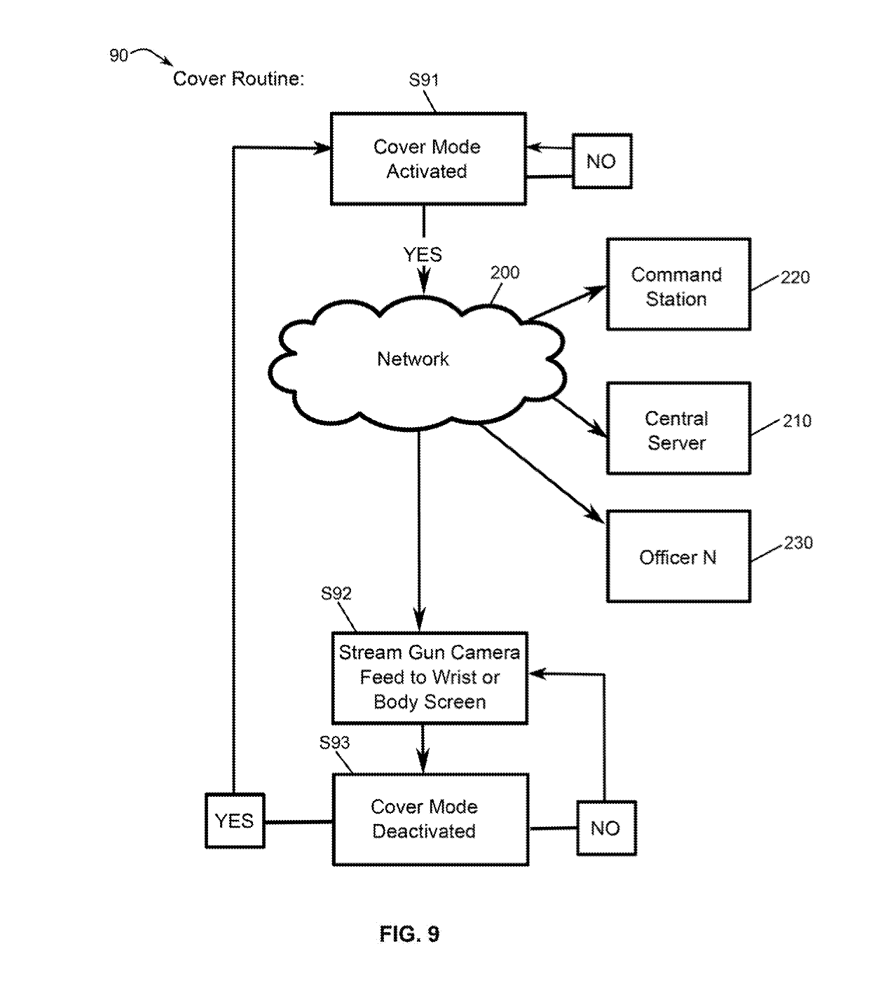

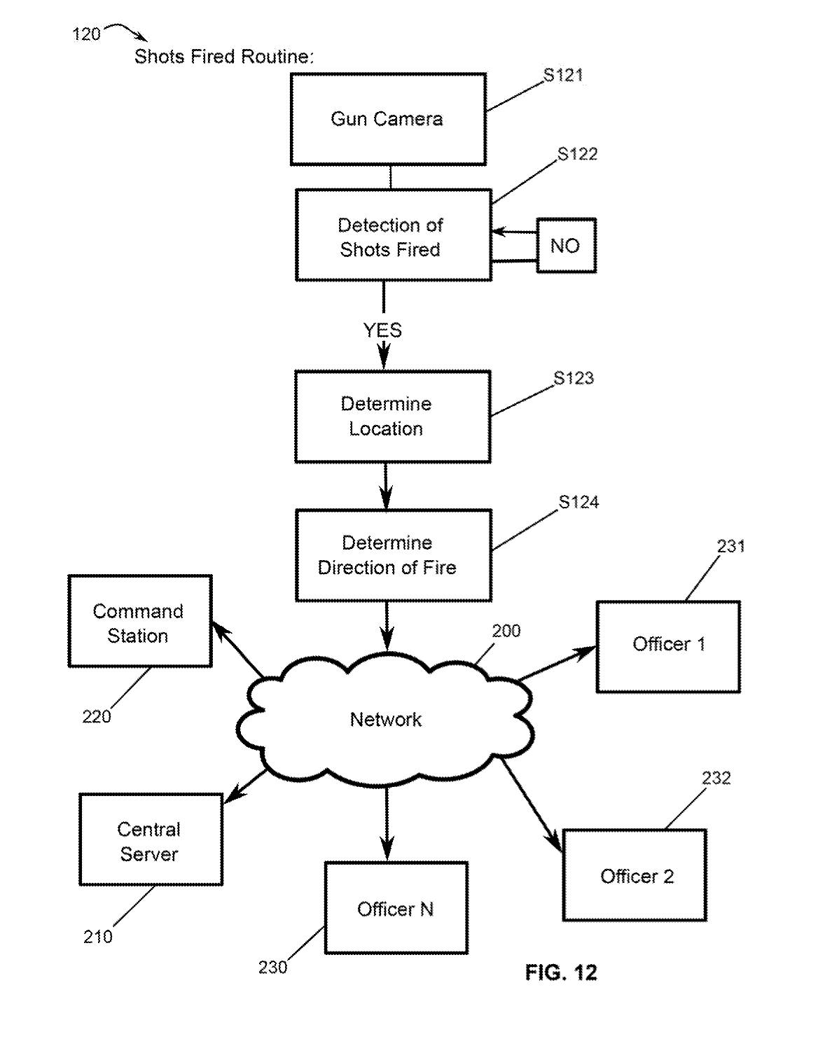

The novel recording device system includes several software and/or firmware applications, which are described herein with reference to FIGS. 9-12. Initially, during an active shooting situation, live video streams from officer's cameras, e.g. body-worn camera, 360 camera, and gun camera can be broadcasted via Wi-Fi, Zigbee, and/or LTE cellular through a police vehicle's on-board system, or through a paired connection with an officer's smartphone that is using the software applications as described herein, which can then be streamed to a central server or headquarters, or to a mobile command center to provide live situational viewing and awareness. While in assist mode and in range, the forearm-communicator, system in-car tablet, or an officer's smartphone that is running the system law enforcement software application, may visually display the location of all officers within a specific area using GPS signals that are emitted by their body-worn camera, weapon-mounted camera, or their 360 degree vehicle-mounted camera. The forearm communicator can also be used as a remote terminal to run information searches, such as driver's licenses and other information.

Referring now to FIG. 9, an officer behind cover routine 90 is disclosed. With the use of the weapon attached camera, the officer can view around corners and blind spots by pointing his weapon camera and viewing the live camera feed on his forearm communicator. An officer may activate cover mode at S91, which triggers a live stream of the weapon attached camera to another device, such as the body camera or forearm communicator at S92. This will allow the officer to visually assess a situation and greatly reduce the risk of injury or death. Additionally, other users devices within the disclosed system, such as other officers 230, a mobile command center 220, or a central server 210, may be configured to be recipients of the live or recorded feed. Once finished, the officer may deactivated cover mode at S93 by, for example, depressing a tactile button on his forearm communicator that has been preprogrammed for such a purpose.

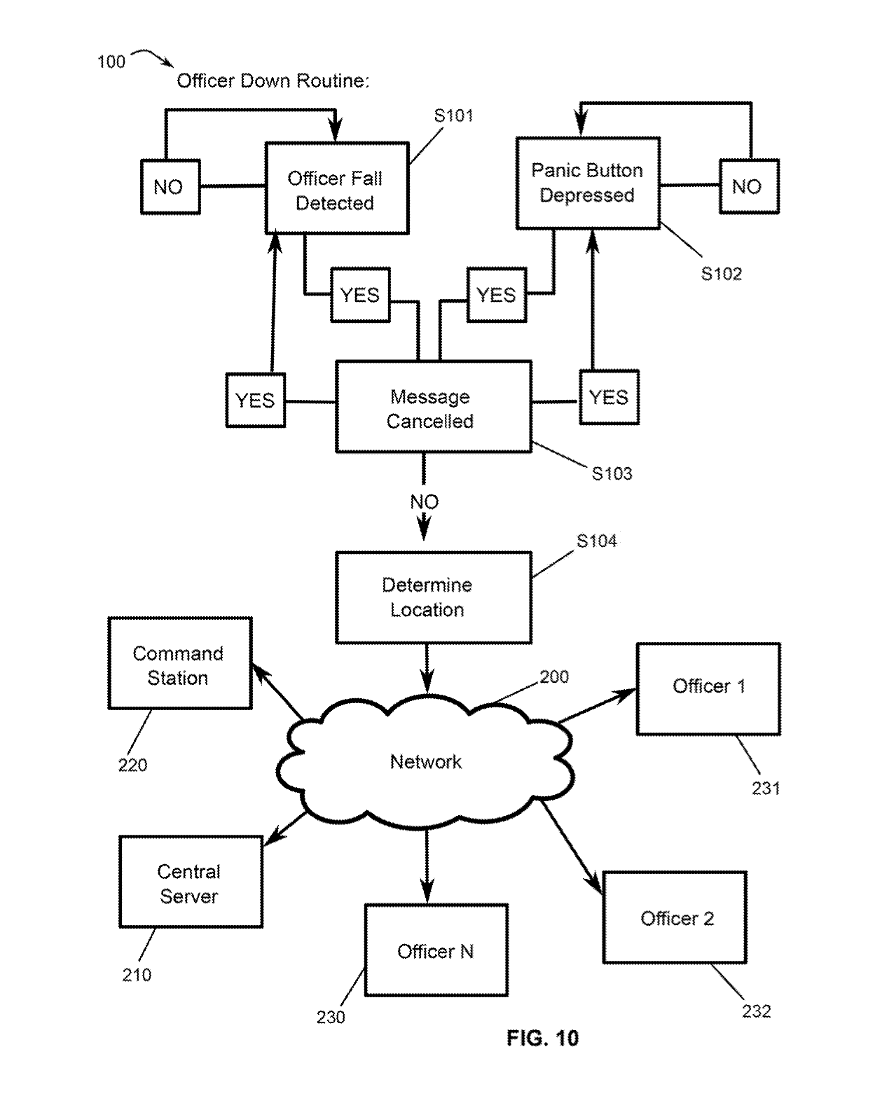

Turning to FIG. 10, an “officer down” call out routine 100 is disclosed. When an officer falls to the ground (S101) or when a preconfigured panic button is pressed on any of the system devices (S102), an event is triggered that will send out mass messages to other officers (any of 230, 231, 232, 210, and/or 220), which will include the troubled officer's exact location (S104). If an officer activates this mode by mistake, it can be canceled within a specified time frame (S103).

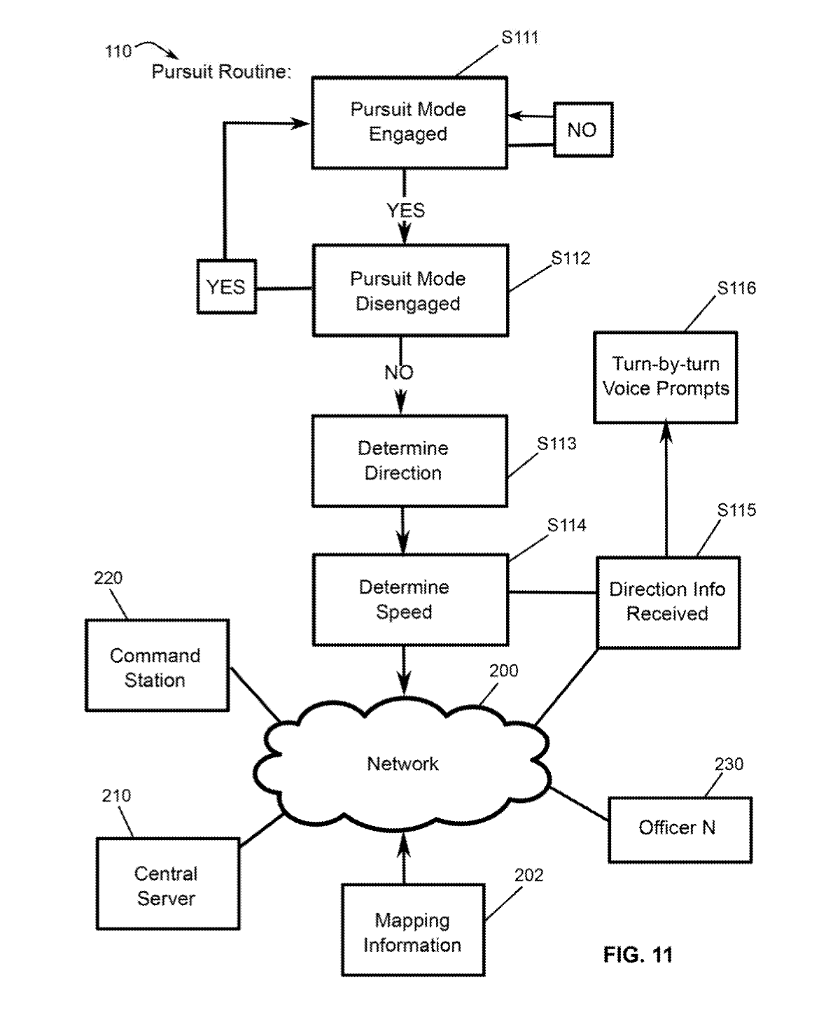

FIG. 11 discloses an officer “in pursuit” routine 110. If an officer is involved in an automotive pursuit, he can activate a call-out mode S111 which may broadcast to central command 220 and/or dispatch, prior to disengagement S112, each turn, direction S113, and speed of the officer's vehicle S114 during the pursuit. This will allow the officer in pursuit to focus on driving, and not have to worry about using his radio to provide location updates. Further, an additional responding officer 230 may receive direction info 5115 back from central command 220, which has taken the location information for each of the pursuing officer and responding officer, calculated a best route using available mapping information 202, and provided said directions, in real time, to the responding officer. For example, the system forearm communicator or 360 camera can provide both visual and turn-by-turn voice prompts to a responding officer S116, of which is the fastest intercepting route, taking into account street topography, and live traffic analysis.

When shots are fired from a weapon within the disclosed system, a “shots fired” routine 120 may be automatically activated. Initially, the gun-mounted camera of the relevant officer will have already been placed in active record mode at S121, since the officer will have necessarily drawn the weapon from its holster. The system is then preferably configured to detect when shots are fired from that same weapon at S122. Once this occurs, the system will generate a message with exact location S123 and direction S124 that their weapon was fired in, which will be broadcasted to command 220 and others configured to receive such a message.

Firearm Safety Features

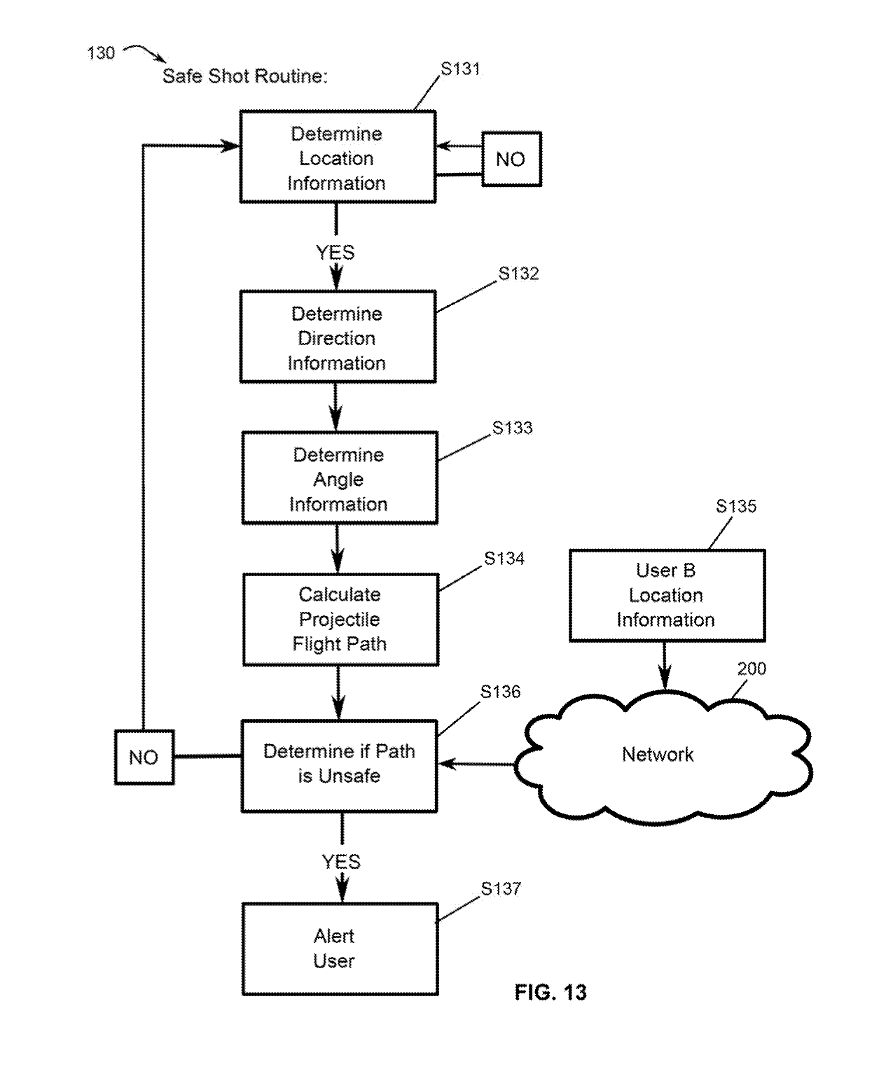

Another aspect of the disclosure is a software/firmware system that works in tandem with some or all of the foregoing hardware, features and embodiments to provide additional weapon safety features for use by law enforcement, public and private security agencies and civilian gun users, among others, and is described with reference to FIG. 13. Among other things, this aspect of the disclosure augments the weapon-mounted camera described herein with a unique application designed for use with all types of smartphones, for example. The software/firmware system may have multiple versions, with one being used exclusively by law enforcement and other security agencies with a specialized system that will be closed and encrypted which will only allow only authorized devices to connect and interact, while a civilian software/firmware system will be designed as an open system and will allow any system civilian devices to connect and interact with any smartphone application running the software/firmware within range.

In certain embodiments, the cameras described herein contain built in Wi-Fi, Zigbee, Bluetooth, and/or cellular capabilities which allow direct and dedicated connection to system software or firmware installed on a user's smartphone, for example. When a user launches the system application on their smartphone, the application utilizes a dedicated Wi-Fi, Zigbee, Bluetooth, and/or cellular signal to recognize and sync with the weapon-camera mounted on the user's gun. The user is then prompted to input the information needed by the system software or firmware to complete the sync process and calibrate the weapon camera with the system application. In one embodiment, a user is asked to input one or more of: the caliber of the weapon and the length of the gun barrel on which the camera has been mounted. For example, the user selects his weapon's caliber from a drop down and/or scrolling menu. Once the caliber is selected, the user is then asked to select a barrel length from a drop down or scrolling menu. Once all of this information is correctly inputted and saved, the system software or firmware then automatically calibrates that information, allowing the system to determine an estimated range and velocity of the weapon when fired.

In one aspect, the system/application contains an updatable database of information relating to multiple weapons/caliber, and weapon/barrel configurations. In one embodiment, the database is configured to be automatically updated with new or modified information through scheduled Wi-Fi or cellular data downloads to the system application on the user's smartphone, for example. When the system software/firmware is calibrated and synced with the weapon camera, it then processes and calculates the velocity and range of the weapon from the inputted data, and utilizes the camera's onboard sensors, and the system software/firmware to cross reference the geo-location data from a maps database, for example Google Maps and/or Google Terrain, to calculate the angle, direction, trajectory, and range of the weapon prior to firing, and further to determine whether or not it is safe to fire the weapon in the direction and angle it is pointed in.

For purposes of the disclosed system, the range and velocity of a weapon are measured by the caliber and the length of the barrel and the accuracy of the weapon over a specific distance, as it will be greatly affected by the length of the barrel. For example, a weapon with a shorter barrel will have less accuracy than a weapon with a longer barrel, which means that when fired, the round will not be able to hold its trajectory as long, which will diminish both the range and the accuracy of the shot.

Turning to FIG. 13, when a weapon-mounted camera is activated and synced with the disclosed system 130, real-time location S131 and positioning S132 is continuously relayed or communicated between the camera and the system application using onboard GPS, magnetic field sensors, and accelerometers, for example. This allows the user to continuously access a maps database such as Google Maps and/or Google Terrain, enabling the user to pin-point his or her real-time location, as well as the real-time location of a fellow system user 5135. The system can determine the angle S133, direction, range and trajectory S134 of the user's weapon, to instantly determine, in real time, if the weapon is pointed at another system user, or any other direction that is not safe to fire in S136. The system, using the real-time geo-location data on the weapon camera, also may issue a visual, vibrating and/or sound alert, to notify a user that another user's weapon is pointed at them S137. For example, if the user's gun is pointed up an incline or into a wooded area, and the user cannot visually detect a fellow system user due to changes in land elevation or obstructions in his or her line of sight, the system may be configured to immediately alert the user that it is not safe to fire in that direction and angle.

In one embodiment, if the weapon holder wishes to understand or clarify the reason why a “not safe to shoot” signal/alert has been issued, the weapon holder can further access the system application to see what information it has received and processed to make that determination. If the operator requires further control, the warnings issued by the system can be customized based on the conditions and circumstances present in the weapon's environment. For example, a law enforcement or security officer in an active and escalated urban situation may require a different warning/alert system than one which would work best for a civilian hunter in the woods.

In certain embodiments, the system uses a vibration warning system on the camera that provides instant feedback to the operator, indicating whether it is unsafe to fire the weapon based on the direction and angle it is pointed in. It may also include alternative “alert options” that can be selected, based on the user's individual preferences, such as vibration alerts from the camera and/or smartphone, LED lights that show green as safe to shoot or red if not safe to shoot, a warning tone and/or screen notification on the smartphone application, or any combination thereof, for example.

In some embodiments, the system can also detect and monitor other system users within a specific distance, almost completely eliminating the risk of being involved in a friendly fire situation. In other words, if an armed individual points his or her weapon in the direction of another user, and the system determines that the direction, range and trajectory of his weapon could possibly hit that other person, a selected alarm and/or vibration immediately alerts the shooter. Accordingly, the system provides such real-time weapon location information via a mapping system that is automatically activated upon smartphone application installation.

In another aspect of the invention, law enforcement officers using the forearm communicator, in-car tablet, and/or a paired smartphone as described above are automatically provided with “mutual user recognition ability”, and the above-described information is clearly shown on their display. But those officers who are not so equipped have the option of utilizing their smartphone or other portable device, with the disclosed system/application installed, to provide the same service.

The present disclosure contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the invention, as defined and differentiated by the following claims.

What is claimed is:

1. A recording system comprising:
a weapon-mounted camera attached to a firearm and a body-worn camera;
wherein said weapon-mounded camera is configured to begin recording video after detecting that said firearm has been removed from a holster;
wherein, if said body camera is within a predefined range of said weapon-mounted camera, and if said detects that said weapon-mounted camera has begun recording video, then said body camera is configured to each begin recording video;
wherein said weapon-mounted camera is configured to calculate a projected bullet path of said firearm; and
wherein said weapon-mounted camera will alter a user if said projected bullet path of said firearm is unsafe.
